(19) United States
(12) Patent Application Publication
(10) Pub. No.: US 2010/0050665 A1
(43) Pub. Date: Mar. 4, 2010

(54) METHOD AND APPARATUS FOR MAINTAINING A UNIFORM TEMPERATURE IN A REFRIGERATION SYSTEM

(75) Inventors: Ian Oswald, Santa Ana, CA (US); Qiao Lu, Placentia, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: B/E Aerospace, Inc., Wellington, FL (US)

(21) Appl. No.: 12/617,950

(22) Filed: Nov. 13, 2009

Related U.S. Application Data
(63) Continuation-in-part of application No. 11/891,692, filed on Aug. 13, 2007.

(51) Int. Cl. F25D 17/06; G05D 7/00

(52) U.S. Cl. 62/89; 62/408; 700/282

(57) ABSTRACT

A refrigeration apparatus includes an air chiller including a fan, a storage enclosure defining a compartment, and a duct system. The air chiller blows chilled air into the duct system. The compartment has first and second openings, each of which is coupled to the duct system. Chilled air enters the first opening and exits the second opening, and vice versa. In one implementation, the first opening is at the top of the compartment and the second opening is at the bottom of the compartment. A control circuit may periodically cause the fan to change the direction of the chilled air flow. This effectively maintains a relatively uniform temperature throughout the compartment.

### CROSS-REFERENCE TO RELATED PATENT APPLICATION

This patent application is a continuation-in-part, of copending U.S. patent application Ser. No. 11/891,692, filed Aug. 13, 2007.

### TECHNICAL FIELD

This application relates generally to food and beverage refrigeration and more particularly, to food and beverage refrigeration systems that alter airflow to maintain uniform temperatures.

### BACKGROUND

Maintaining a relatively uniform temperature is important in any refrigeration system, but it is particularly important in the context of food and beverage refrigeration. Without proper temperature distribution, some food in a refrigerator will be too cold, resulting in unwanted freezing and some will be too warm, which raises the risk of spoilage. In most contexts, a uniform temperature is not only desirable, but is mandated by regulations.

Typically, pre-prepared airline food is stored in galley carts prior to serving to passengers. However, current galley cooling systems have to force air just above freezing either into the galley carts or into insulated compartments containing several galley carts just to ensure that the temperature does not exceed the required temperature in any portion of the carts. This is due to the temperature increase as the air passes through or over the galley carts to remove the heat entering the galley cart or compartment. The lower the maximum temperature required means that the cold air source is less efficient resulting in the need to use more powerful and heavier systems that use more electrical power. Thus, it can be seen that there is a need for a new method and apparatus for maintaining a uniform temperature in a refrigeration system.

### SUMMARY

In accordance with the foregoing, a method and apparatus for maintaining a uniform temperature in a refrigeration system is provided. According to an embodiment of the invention, the method involves directing chilled air through a galley cart or compartment in a first direction, switching the flow of the chilled air to a second direction (substantially opposite the first direction), and periodically repeating these steps. In another embodiment, the apparatus includes an air chiller, a storage enclosure defining a compartment, a duct system, and a valve system. The air chiller blows chilled air into the duct system. The compartment has a first and a second opening, each of which is coupled to the duct system. The valve system has valves that can be moved to route the chilled air so that it enters into the first opening and exits the second opening, or vice versa. In one embodiment, the first opening is at the top of the compartment and the second opening is at the bottom of the compartment, and the valve system is controlled by a control circuit that periodically switches the valves (via an actuator) to change the direction of the chilled air. This effectively maintains a relatively uniform temperature throughout the compartment.

According to another embodiment of the invention, the method comprises blowing chilled air through the compartment in a first airflow direction, then reversing a rotational direction of fan rotation and blowing chilled air through the compartment in a second airflow direction that is substantially opposite the first airflow direction, and then reversing the rotational direction of fan rotation and blowing chilled air through the compartment in the first airflow direction.

In another embodiment, an apparatus is provided for cooling food or beverages. The apparatus comprises an air chiller including first and second chiller ports and a fan having forward and reverse settings; a storage enclosure defining a compartment, the storage enclosure having a first opening and a second opening, which permits air to pass between the compartment and the outside of the enclosure; and a duct system coupled to the first and second chiller ports and to the first and second openings. The chilled air flows from the first chiller port into the duct system in a first airflow direction when the fan operates in the forward setting, and chilled air flows from the second chiller port into the duct system in a second airflow direction, that is substantially opposite the first airflow direction, when the fan operates in the reverse setting.

In another embodiment a system is provided for cooling food or beverages. The galley cooling system comprises an enclosure; a cooling unit that generates chilled air, the cooling unit including a fan having forward and reverse settings; a duct system that transports the chilled air; and a plurality of carts disposed at least partially within the enclosure. Each cart of the plurality comprises a compartment, and has a first opening that connects the compartment to the duct system and a second opening that connects the compartment to the duct system. When the fan is in a forward setting, the chilled air is routed in a first airflow direction into the second opening of each of the plurality of carts and out of the first opening of each of the plurality of carts. When the fan is in a reverse setting, the chilled air is routed, in a second airflow direction that is substantially opposite to the first airflow direction, into the first opening of each of the plurality of carts and out of the second opening of each of the plurality of carts.

### BRIEF DESCRIPTION OF THE DRAWINGS

FIG. 1 shows a back perspective view of a galley cart that may be used in conjunction with an embodiment of the invention.

FIG. 2 shows the cart depicted in FIG. 1 with the door open.

FIG. 3 is a front elevational view of a refrigeration system configured according to an embodiment of the invention, in which the valve system is in a first configuration.

FIG. 4 is a view of the refrigeration system of FIG. 3 in which the valve system is in a second configuration.

FIG. 5 is a schematic of an embodiment of the refrigeration system in which the air is blown in the forward airflow direction through the galley cart.

FIG. 6 is a schematic of the embodiment of the refrigeration system of FIG. 5 in which the air is sucked in the reverse airflow direction through the galley cart.

FIG. 7 is a schematic of an embodiment illustrating a change in the air temperature as it circulates through the refrigeration system of FIG. 5.

FIG. 8 is a schematic of an embodiment illustrating a change in the air temperature as it circulates through the refrigeration system of FIG. 6.

### DETAILED DESCRIPTION

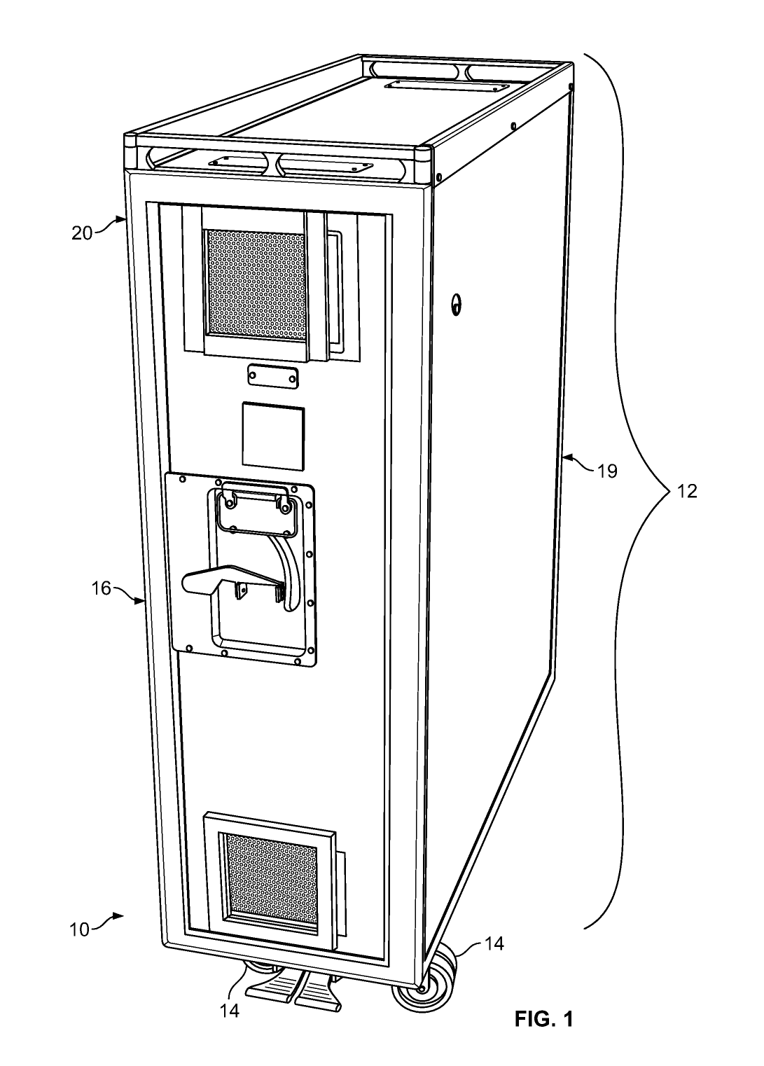

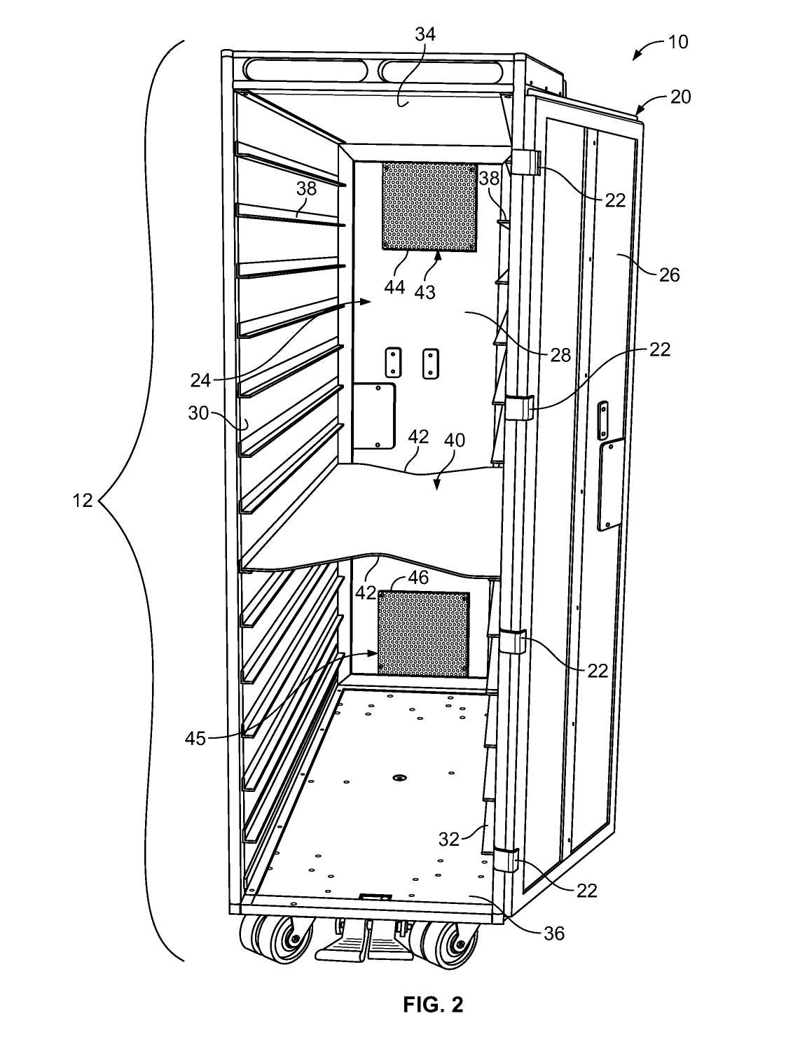

Referring to FIGS. 1 and 2, a galley cart that is used in conjunction with an embodiment is shown. The cart, generally labeled 10, includes an enclosure 12 and castors 14 attached to the bottom of the enclosure 12. The enclosure 12 has a front side 16 and a back side 19. A door 20 is attached to the front side 16 by hinges 22. The enclosure 12 has a storage compartment 24 defined by an inner surface 26 of the door 20, a back wall 28, a first side wall 30, a second side wall 32, a ceiling 34, and a floor 36.

Protruding from the first and second side walls 30 and 32, are rails 38, which are configured to hold food trays. The enclosure 12 also has a divider 40 attached to the first and second side walls 30 and 32. The divider 40 is disposed at or about the vertical midway point of the side walls 30 and 32. The divider 40 has a pair of generally V-shaped cutouts 42, one proximate to the door 20 and one proximate to the back wall 28. The back wall 28 has a pair of generally square openings, a first opening 43 and a second opening 45, in which a first grill 44 and a second grill 46 are disposed. The first and second openings 43 and 45 link the storage compartment 24 with the outside of the enclosure 12, allowing air to move in or out through the grills 44 and 46.

The first grill 44 is located proximate to the ceiling 34 while the second grill 46 is located proximate to the floor 36. The first and second grills 44 and 46 permit air to flow through the back wall 28.

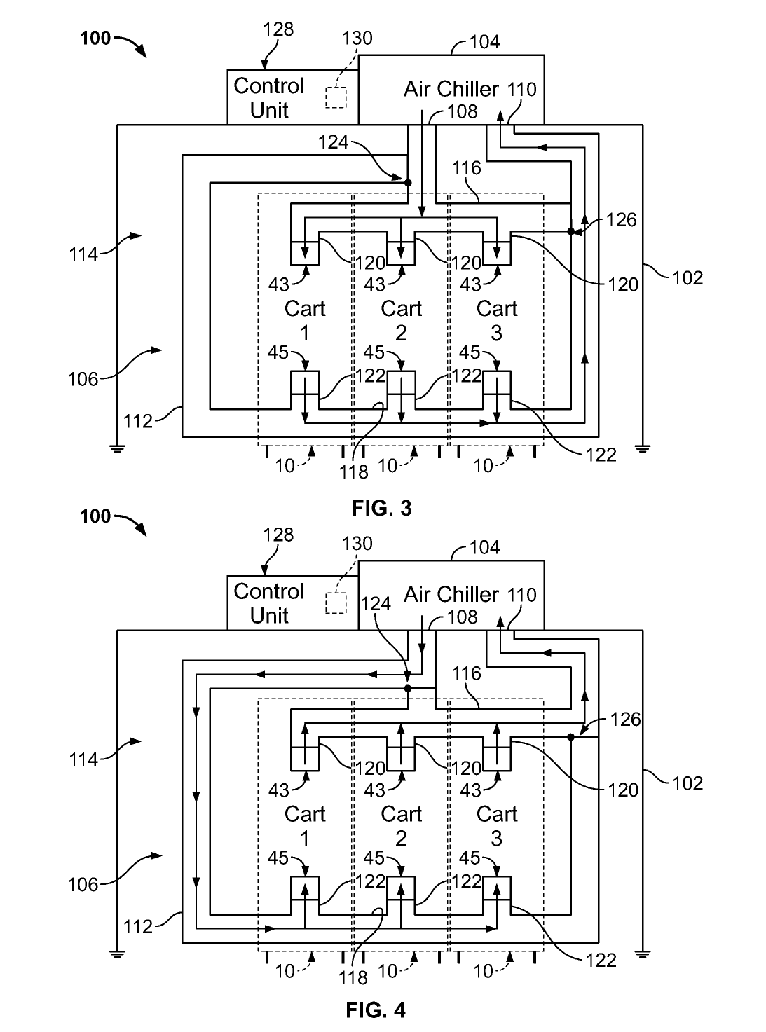

Referring to FIG. 3, an example of a refrigeration system configured according to an embodiment of the invention will now be described. The system, generally labeled 100, includes a cart corral 102, an air chiller 104 disposed on top of the cart corral 102, and a duct system 106 disposed within the cart corral 102. The duct system has an inlet 108 and an outlet 110. The air chiller 104 has an outlet that is coupled to the inlet 108 of the duct system 106. The air chiller 104 also has an inlet that is coupled to the outlet 110 of the duct system 106.

The duct system 106 has a main duct 112 that extends around the inner periphery of the cart corral 102. The main duct 112 starts at the inlet 108 of the duct system 106 and terminates at the outlet 110 of the duct system 106.

The cart corral 102 has an open side 114 that enables a cart to be parked within the corral 102. FIG. 3 shows 3 carts, each of the carts being parked within the corral 102. Cart 10 in this example will be assumed to have the same configuration as the cart 10 of FIG. 1. Each cart 10 is parked so that its front side 16 faces the open side 114 of the cart corral 102.

In addition to the main duct 112, the duct system 106 includes a first branch 116 and a second branch 118. The first branch 116 has openings 120 that are next to or coupled with the first openings 43 of the carts 10. Similarly, the second branch 118 has openings 122 that are next to or coupled with the second openings 45 of the carts 10.

Disposed within the duct system 106 is a valve system, which includes a first valve 124 and a second valve 126. The refrigeration system 100 also includes a control unit 128. The control unit 128 includes a control circuit 130, which controls the movement of the first and second valves 124 and 126 by sending signals to an actuator that is mechanically coupled to the first and second valves 124 and 126. The first valve 124 has at least two positions—a first position, shown in FIG. 3, in which the first valve 124 directs air flowing from the inlet 108 of the duct system 106 to flow to the first branch 116, and a second position, shown in FIG. 4, in which the first valve 124 prevents air flowing from the inlet 108 of the duct system 106 directly to the first branch 116. The second valve 126 also has at least two positions—a first position, shown in FIG. 3, in which the second valve 126 prevents air from flowing from the first branch 116 to the main duct 112, and a second position, shown in FIG. 4, in which the second valve 126 permits air to flow from the first branch 116 to the main duct 112.

The refrigeration system 100 has at least two modes of operation—a normal airflow mode and a reversed airflow mode. The normal airflow mode will now be described with respect to FIG. 3. In the normal airflow mode, the valve system is in a configuration in which the first valve 124 and the second valve 126 are in their respective first positions. The air chiller 104 blows chilled air into the inlet 108 of the duct system 106. Because the first valve 124 prevents airflow directly from the inlet 108 to the main duct 112, the air flows from the inlet 108 to the first branch 116, and then flows through openings 120 of the first branch 116 and through the first openings 43 of the carts 10. The chilled air flows through the storage compartment 24 of each cart 10, through the generally V-shaped cutouts 42, and out the second openings 45 of the carts 10. The chilled air exiting the second openings 45 passes through the second branch 118 and proceeds to the main duct 112 and out the outlet 110.

The reverse airflow mode will now be described with reference to FIG. 4. In the reverse airflow mode, the valve system is in a configuration in which the first valve 124 and the second valve 126 are in their respective second positions. The first valve 124 in its second position directs airflow from the inlet 108 to the main duct 112. With the second valve 126 in its second position, airflow from the main duct 112 is prevented from flowing directly back to the chiller 104 through the outlet 110. Instead, the air flows from the main duct 112 into the second branch 118, through the openings 122 of the second branch 118, and through the second openings 45 of the carts 10. The chilled air then passes through the storage compartment 24 of each cart 10, through the generally V-shaped cutouts 42, and out the first openings 43 of the carts 10. The chilled air exiting the first openings 43 passes through first branch 116 and proceeds to the main duct 112 and back to the chiller 104 through the outlet 110.

According to an embodiment of the invention, the refrigeration system periodically switches from the normal airflow mode to the reverse airflow mode. The time interval for switching the airflow can depend on many factors, such as the desired temperature of the system, and may also depend upon a sensed temperature of the system. This could include, for example, temperature sensors that determine whether there is a difference between the temperature at the top of a cart as compared to the temperature at the bottom of a cart. If such a difference exceeds a particular threshold, the airflow may be switched to provide more uniform cooling. In one implementation, the switching may occur periodically from 2 to 30 minutes. The switching between the normal mode and the reverse mode is controlled by the control circuit 130 of the control unit 128. Periodically reversing the flow of air helps to equalize the temperature throughout the compartment 24.

As should be appreciate by one of skill in the art, the foregoing describes an embodiment where three different carts are accommodated within the cooling system of the present invention. The same invention may be readily implemented with respect to more or less carts. For example, the invention may be implemented with respect to just one cart, where two valves are operated to direct airflow through the cart initially in one direction, then to direct airflow through the cart in the other direction.

In another embodiment of the invention, the air chiller includes a fan having both a forward and a reverse setting that allows the chiller to generate bi-directional airflow. This removes the need to rely on a valve set to create bi-directional airflow through the galley carts. Furthermore, it reduces the frequency with which the air chiller must be defrosted.

In a system in which the chilled air generally exits the chiller through the same outlet, such chilled air exiting the outlet is much cooler than the air returning to the chiller through its inlet. In some embodiments, the temperature difference between the chiller outlet and inlet may be about 12-15° F. Over time, frost and ice build up in the chiller inlet and can block the flow of air back into the chiller. The chiller must then be shut down and defrosted. In a chiller having bi-directional flow of chilled air, the build-up of frost is slowed because it is spread over two ports instead of one outlet. As with the functioning of the valve set in FIGS. 3-4, bi-directional airflow from the chiller evens the temperature distribution in the galley carts. In the forward setting, the chiller fan functions in the blower mode. In the reverse setting, the chiller fan functions in the suction mode. The mode of the fan may be determined by a timer, a temperature sensor or other appropriate device. A chiller having such bi-directional airflow may be used in conjunction with refrigeration systems without valves that direct airflow and may also be used with refrigeration systems that include valves for directing airflow. When a chiller having such bi-directional airflow is used in an embodiment of a refrigeration system such as that illustrated in FIG. 3, the first and second valves may be maintained in either the first position or in the second position; it is not necessary to move the first and second valves from one position to another in order to have bi-directional airflow through the galley carts.

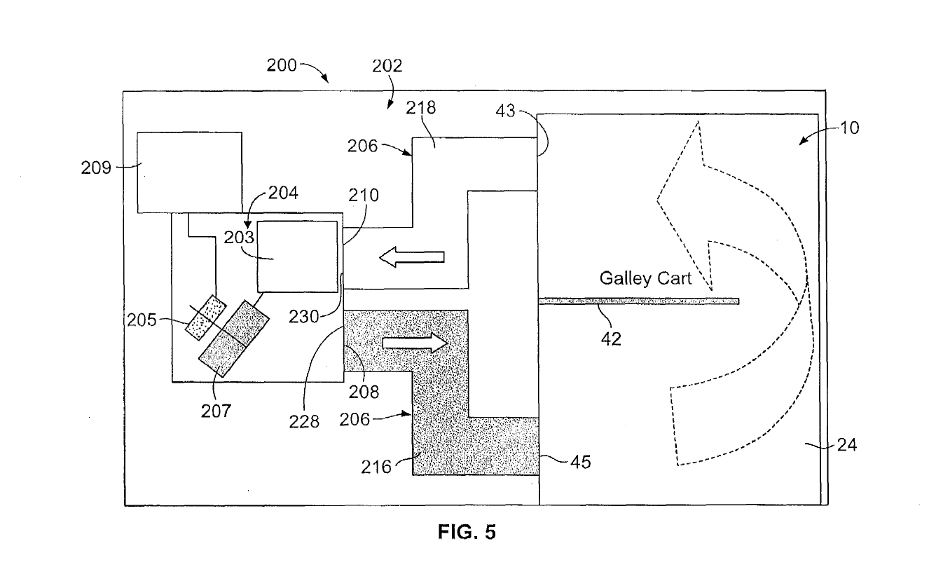

FIG. 5 illustrates a side view of a refrigeration system configured according to an embodiment of the invention. In FIG. 5 the refrigeration system, generally labeled 200, comprises a galley cooling system 202 including an air chiller 204 and a duct system 206 disposed within the galley cooling system 202. The duct system 206 has a first port 208 and a second port 210. The air chiller 204 is comprised of an evaporator 203, a fan motor 205, and a fan 207. The chiller 204 may be connected to a device 209 such as a temperature controller, and/or a timer or sensor. The device 209 in the preferred embodiment is an electronic device. The air chiller 204 has a first chiller port 228 that is coupled to the first port 208 of the duct system 206. The air chiller 204 also has a second chiller port 230 that is coupled to the second port 210 of the duct system 206. The duct system has a primary branch 216 and a secondary branch 218. The primary branch starts at the first port 208 of the duct system 206 and extends to the second opening 45 of the cart 10. The secondary branch extends between the first opening 43 of the cart 10 and the second port 210 of the duct system 206.

As depicted in FIG. 5, in the forward setting, the fan 207 blows chilled air through the first port 208 into the primary branch 216 of the duct system 206. The air flows through the primary branch 216 into the lower portion of the storage compartment 24 of the cart 10 through the second opening 45 in the cart. The air flows from the bottom of the cart 10 to the top of the cart 10. Thus, the chilled air passes through the storage compartment 24 of the cart 10, through the generally V-shaped cutouts 42, and out of the first opening 43 of the cart 10. The chilled air exiting the first opening 43 passes through secondary branch 218 and back to the chiller 204 through the second port 210.

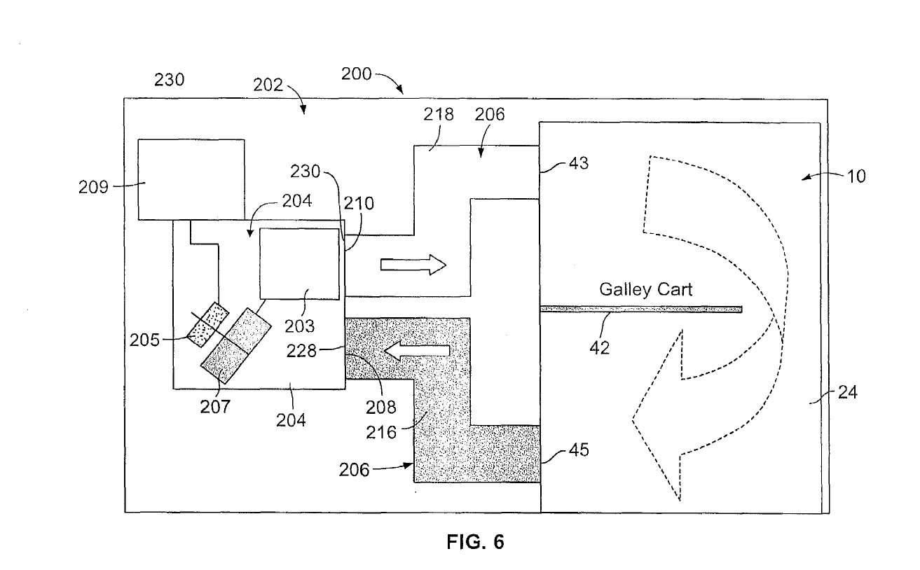

FIG. 6 illustrates a side view of the refrigeration system 200 of FIG. 5 with the fan in the reverse setting functioning in the suction mode and the air flowing in the reverse direction as that in FIG. 5. In the suction mode, the fan 207 sucks air in from the primary branch 216 and blows chilled air into the secondary branch 218 of the duct system 206 through the second port 210. The air flows from the secondary branch 218 into the upper portion of the storage compartment 24 of the cart 10 through the first opening 43. The air flow in the galley cart 10 is from top to bottom. Thus, the chilled air passes through the storage compartment 24 of the cart 10, through the generally V-shaped cutouts 42, and out the second opening 45 of the cart 10. The chilled air exiting the second opening 45 passes through the primary branch 216 and back to the chiller 204 through the first port 208. In the embodiments shown in FIGS. 5-6 only one cart is illustrated. However, in other embodiments, the galley cooling system may have a plurality of carts docked to it.

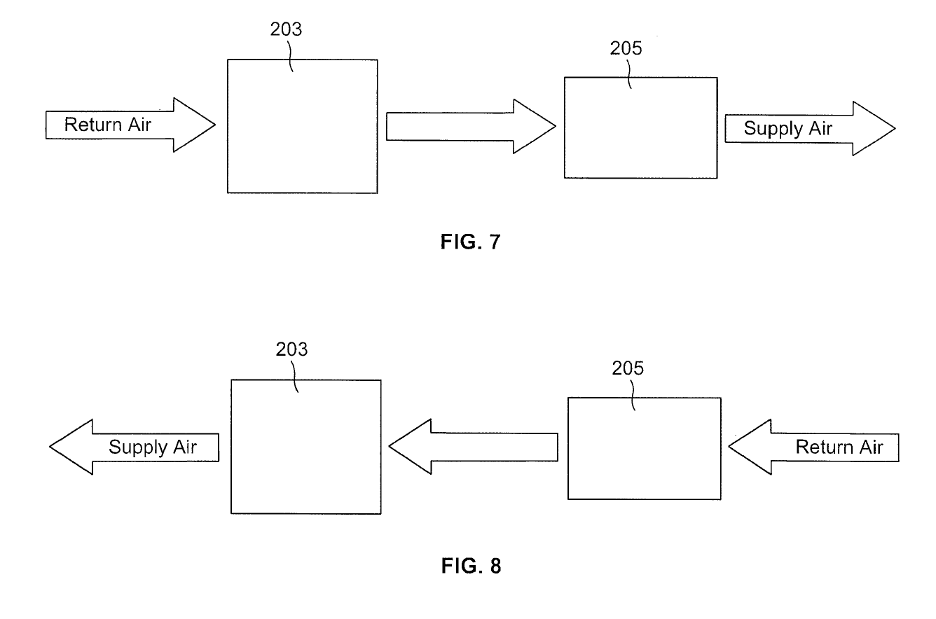

FIG. 7 is a schematic illustrating the flow of air through the chiller in the preferred embodiment of FIG. 5. In this embodiment, air returning from the galley cart 10 (FIG. 5) enters the air chiller (204) and is circulated through the evaporator 203 of the air chiller 204 (FIG. 5). When the fan 207 is in the forward setting, the air entering the evaporator 203 is cooled by the evaporator such that chilled air flows from the evaporator 203 to the fan 207. The air may be warmed slightly when passing through the fan motor 205 and may exit the fan 207 into the primary branch 216 and then the galley cart 10 at a slightly higher temperature. For example, in an embodiment when the fan 207 is in the forward setting, the air entering the evaporator 203 may be about 45° F. The temperature of the evaporator, in this example may be about 21.3° F. The evaporator 203 cools the air circulating through it so that the chilled air flowing from the evaporator 203 to the fan motor 205 is about 30° F. The air may be warmed slightly when passing through the fan motor 205 and may exit the fan 207 into the primary branch 216 and then the galley cart at a slightly higher temperature. For example, the air may exit the fan 207 at about 31° F.

FIG. 8 illustrates a schematic of the flow of air through the chiller in the embodiment of FIG. 6. When the fan 207 is operating in suction mode (FIG. 6), the return air enters the fan 207 from the primary branch 216 (FIG. 6) of the duct system 206. When the return air passes through the fan motor 205 and exits the fan motor 205 into the evaporator 203 it may be slightly warmed by the fan. However, as the air passes over the refrigerator coils of the evaporator 203, its temperature drops and chilled air exits the evaporator 203. For example, when the air enters the fan, it may be about 45° F. This return air passes through the fan motor 205 and exits the fan motor 205 into the evaporator 203 at about 46° F. In an embodiment, the temperature of the evaporator 203 may be about 22.3° F. Air passes over the refrigerator coils of the evaporator 203 resulting in a drop in temperature. In some embodiments there may be about a 15° F. drop in temperature and the air may exit the evaporator 203 at about 31° F. The higher evaporating temperature reduces the power consumption of the refrigeration system because the higher evaporating temperature decreases the compression ratio in the refrigeration system, when the condensing temperature is the same. The lower compression ratio reduces the power consumption of the refrigeration system.

According to an embodiment of the invention, the refrigeration system periodically switches from the forward airflow to the reverse airflow. The time interval for switching the airflow can depend on many factors, such as the desired temperature of the system, and may also depend upon a sensed temperature of the system. This could include, for example, temperature sensors that determine whether there is a difference between the temperature at the top of a cart as compared to the temperature at the bottom of a cart. If such a difference exceeds a particular threshold, the airflow may be switched to provide more uniform cooling. In one implementation, the switching may occur periodically from 2 to 30 minutes. The switching between the forward mode and the reverse mode may be controlled by the control circuit 130 of the control unit 128. In another embodiment, an air pressure differential sensor may be used to monitor the air pressure difference between the inlet and outlet of the evaporator. If the air pressure difference exceeds a particular threshold, the airflow may be reversed.

It can be seen from the foregoing that a new and useful method and system for identifying and managing currency exposure has been described. The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

We claim:

1. A method for cooling a food or beverage compartment, the method comprising:
(a) blowing chilled air through the compartment in a first airflow direction;
(b) after step (a), reversing a rotational direction of fan rotation and blowing chilled air through the compartment in a second airflow direction that is substantially opposite the first airflow direction; and
(c) after step (b), reversing the rotational direction of fan rotation and blowing chilled air through the compartment in the first airflow direction.

2. The method of claim 1, further comprising waiting for a predetermined interval of time after step (a) before performing step (b).

3. The method of claim 1, wherein the first airflow direction is from the bottom of the compartment to the top of the compartment and the second airflow direction is from the top of the compartment to the bottom of the compartment.

4. The method of claim 1, in which step (a) further comprises cooling air with an evaporator to generate chilled air to be blown through the compartment in the first airflow direction.

5. The method of claim 4, in which step (b) further comprises cooling air with the evaporator to generate chilled air to be blown through the compartment in the second airflow direction.

6. The method of claim 1, in which step (a) further comprises blowing chilled air through a duct system in the first airflow direction and step (b) further comprises blowing chilled air through the duct system in the second airflow direction, wherein the duct system is connected to the compartment.

7. The method of claim 6, wherein the duct system is comprised of a primary branch and a secondary branch.

8. The method of claim 1, wherein step (a) comprises directing the chilled air into a second opening of the compartment and out of a first opening of the compartment and wherein step (b) comprises directing the chilled air into the first opening of the compartment and out of the second opening of the compartment.

9. An apparatus for cooling food or beverages, the apparatus comprising:
an air chiller including first and second chiller ports and a fan having forward and reverse settings;
a storage enclosure defining a compartment, the storage enclosure having a first opening and a second opening, which permits air to pass between the compartment and the outside of the enclosure; and
a duct system coupled to the first and second chiller ports and to the first and second openings,
wherein chilled air flows from the first chiller port into the duct system in a first airflow direction when the fan operates in the forward setting, and chilled air flows from the second chiller port into the duct system in a second airflow direction, that is substantially opposite the first airflow direction, when the fan operates in the reverse setting.

10. The apparatus of claim 9, further comprising a divider disposed within the compartment wherein the divider divides the compartment into an upper portion and a lower portion, the divider having a cutout that permits cool air to flow between the upper and lower portions.

11. The apparatus of claim 9, wherein the storage enclosure has a top and a bottom, the first opening being located proximate to the top and the second opening being located proximate to the bottom.

12. The apparatus of claim 9, wherein the duct system comprises a first branch coupled to the second opening, and a second branch coupled to the first opening.

13. The apparatus of claim 12, wherein when the fan operates in the reverse setting, the fan sucks air in from the first branch.

14. The apparatus of claim 13, in which the chiller further comprises an evaporator and the air sucked in from the first branch is chilled by the evaporator.

15. The apparatus of claim 9, further comprising a control circuit that periodically initiates switching the fan from the forward setting to the reverse setting.

16. A system for cooling food or beverages, the system comprising:
an enclosure;
a cooling unit that generates chilled air, the cooling unit including a fan having forward and reverse settings;
a duct system that transports the chilled air; and
a plurality of carts disposed at least partially within the enclosure, each cart of the plurality comprising a compartment, and having a first opening that connects the compartment to the duct system and a second opening that connects the compartment to the duct system,
wherein, when the fan is in a forward setting, the chilled air is routed in a first airflow direction into the second opening of each of the plurality of carts and out of the first opening of each of the plurality of carts, and when the fan is in a reverse setting, the chilled air is routed, in a second airflow direction that is substantially opposite to the first airflow direction, into the first opening of each of the plurality of carts and out of the second opening of each of the plurality of carts.

17. The system of claim 16, further comprising a control circuit that controls the interval of time between which the fan is in the forward setting and in which the fan is in the reverse setting.

18. The system of claim 17, wherein the interval of time is about 2 to 30 minutes.

19. The system of claim 18, wherein the chilled air exiting the air chiller is at a temperature of about 31° F.

20. The system of claim 16, wherein the first opening is proximate to the top of each cart and the second opening is proximate to the bottom on each cart.
